(19) United States
(12) Patent Application Publication
(10) Pub. No.: US 2020/0219183 A1
(43) Pub. Date: Jul. 9, 2020

(54) METHOD, SYSTEM, AND NON-TRANSITORY COMPUTER READABLE RECORD MEDIUM FOR PROVIDING CONVENIENCE FUNCTIONS RELATED TO BANK ACCOUNT TRANSACTION HISTORY BASED ON MESSENGER

(71) Applicant: LINE CORPORATION, Tokyo (JP)

(72) Inventors: Sun-Haeng CHO, Seongnam-si (KR); Ji Yeon CHEON, Seongnam-si (KR)

(73) Assignee: LINE CORPORATION, Tokyo (JP)

(21) Appl. No.: 16/730,014

(22) Filed: Dec. 30, 2019

(30) Foreign Application Priority Data
Jan. 4, 2019 (KR) 10-2019-0001036

(51) Int. Cl. G06Q 40/02; H04L 12/58

(52) U.S. Cl. CPC G06Q 40/02; H04L 51/046

(57) ABSTRACT

Provided are a method, a system, and a non-transitory computer readable record medium for providing convenience functions related to an account transaction history based on a messenger. An account transaction history providing method includes loading a transaction history of an account based on receiving a transaction history request for the account; verifying information on a messenger that matches a counterpart included in the transaction history; and displaying transaction details for each transaction of the transaction history through a chatroom created for the account based on a message in association with a profile set as user information of the counterpart on a messenger.

### CROSS-REFERENCE TO RELATED APPLICATION

This U.S. non-provisional application claims priority from Korean Patent Application No. 10-2019-0001036, filed on Jan. 4, 2019 in the Korean Intellectual Property Office (KIPO), the disclosure of which is incorporated herein by reference in its entirety.

### BACKGROUND

### 1. Field

Apparatuses and methods consistent with example embodiments relate to providing a transaction history of an account in a messenger banking service.

### 2. Description of Related Art

An instant messenger that is a general communication tool refers to software capable of sending and receiving messages or data in real time. A user may register a contact on a messenger and may exchange messages with a counterpart included in a contact list in real time.

As the use of the instant messenger becomes popular and functions provided through the instant messenger are diversified and improved, there is a need for a user interface for convenient financial transactions through the instant messenger.

### SUMMARY

One or more example embodiments provide a transaction history of an account in a form of a chatroom and to provide a profile of a transaction target on a messenger for each transaction.

Further, one or more example embodiments provide a function of a memo, a notification, etc., through an interface in a corresponding chatroom through the chatroom that provides a transaction history of an account for user convenience.

Still further, one or more example embodiments provide a method and an apparatus for filtering of a transaction history with a specific target through a selection on a profile in a transaction history chatroom and to provide the filtered transaction history.

Still further, one or more example embodiments provide, with respect to a transaction target having an official account of a messenger, a method and an apparatus for providing content associated with the transaction target through a transaction history chatroom.

According to an aspect of an example embodiment, there is provided a computer system including: a memory configured to store computer-readable instructions; at least one processor configured to execute the computer-readable instructions to: load a transaction history of an account of a user of a messenger application in response to receiving a transaction history request for the account; verify whether a transaction counterpart included in the transaction history of the user is registered in the messenger application; and in response to verifying that the transaction counterpart is registered in the messenger application, display, in a chatroom created for the account to, transaction details for each transaction of the transaction history in a message form in association with a profile of the transaction counterpart registered in the messenger application.

The at least one processor may be further configured to classify the transaction history into a withdrawal history and a deposit history and control to display the transaction details visually distinctly according to a classification of the transaction history.

The at least one processor may be further configured to display a profile of the user of the account on the messenger application or the profile of the transaction counterpart on the messenger application based on a transaction type.

The at least one processor may be further configured to provide a user interface that is incorporated into the chatroom and initiates at least one of a memo function for entering a memo to the chatroom or an alert function for setting an alert associated with the chatroom.

The at least one processor may be further configured to generate a memo message including the memo and control to display the memo message in the chatroom in response to receiving a memo registration request, or generate an alert message including the alert and control to display the alert message in the chatroom in response to receiving an alarm setting request.

The at least one processor may be further configured to select the transaction history associated with the transaction counterpart, among a plurality of transaction counterparts included in the transaction history, and open a new display window to display the selected transaction history in the new display window, in response to selecting the profile of the transaction counterpart in the chatroom.

The at least one processor may be further configured to provide content designated for an official account of the transaction counterpart in the new display window in response to the official account being registered in the messenger application.

According to an aspect of another example embodiment, there is provided an account transaction history providing method including: loading a transaction history of an account of a user of a messenger application in response to receiving a transaction history request for the account; verifying where a transaction counterpart included in the transaction history of the user is registered in the messenger application; and in response to verifying that the transaction counterpart is registered on the messenger application, displaying, in a chatroom created for the account to, transaction details for each transaction of the transaction history in a message form in association with a profile of the transaction counterpart registered in the messenger application.

The account transaction history providing method may further include displaying the transaction history by classifying the transaction history into a withdrawal history and a deposit history, and displaying the transaction details visually distinctly according to a classification of the transaction history.

The account transaction history providing method may further include: displaying a profile of the user of the account on the messenger application or the profile of the transaction counterpart on the messenger application based on a transaction type.

The account transaction history providing method may further include: displaying a profile of the user of the account in association with a withdrawal history of the transaction history; and displaying the profile of the transaction counterpart in response to an official account of the transaction counterpart being registered in the messenger application.

The account transaction history providing method may further include: providing a user interface that is incorporated into the chatroom and initiates at least one of a remittance function, a payment function, and a withdrawal function.

The account transaction history providing method may further include: providing a user interface that initiates at least one of a memo function for entering a memo to the chatroom or an alert function for setting an alert associated with the chatroom.

The account transaction history providing method may further include: generating a memo message including the memo and displaying the memo message in the chatroom in response to receiving a memo registration request, or generating an alert message including the alert and displaying the alert message in the chatroom in response to receiving an alarm setting request.

The account transaction history providing method may further include: selecting the transaction history associated with transaction counterpart, among a plurality of transaction counterparts included in the transaction history; and opening a new display window to display the selected transaction history in the new display window, in response to selecting the profile of the transaction counterpart in the chatroom.

The opening the new display window to display selected transaction history in the new display window may include providing a user interface that initiates at least one of a remittance function, a memo function, and an alert function for the transaction counterpart.

The opening the new display window to display selected transaction history in the new display window may include providing content designated for an official account of the transaction counterpart in the new display window in response to the official account being registered in the messenger application.

The opening the new display window to display selected transaction history in the new display window may include in response to determining that the transaction counterpart has an official account registered in the messenger application, and the transaction history associated with the transaction counterpart satisfies a display condition of a content designated for the official account, providing the content designated for the official account in the new display window.

According to an aspect of another example embodiment, there is provided a non-transitory computer-readable storage medium storing a computer program that is executable by a computer to perform the account transaction history providing method.

According to an aspect of another example embodiment, there is provided a computer system including: a memory configured to store computer-readable instructions; at least one processor configured to execute the computer-readable instructions to: load a transaction history of an account of a user registered in a messenger application; identify at least one transaction counterpart to a plurality of transactions included in the transaction history; determine a transaction type of each of the plurality of transactions, the transaction type corresponding to a balance increasing transaction type or a balance decreasing transaction type; and in response to determining that the at least one transaction counterpart is registered in the messenger application, create a graphic user interface of a chatroom for the account of the user, generate messages that respectively contain details of the plurality of transactions, and determine a layout of each of the messages in the chatroom according to the transaction type of each of the plurality of transactions.

The at least one processor may be further configured to execute the computer-readable instructions to: align at least one of the messages corresponding to the balance increasing transaction type on a right side of the chatroom and align at least one of the messages corresponding to the balance decreasing transaction type on a left side of the chatroom, or align the at least one of the messages corresponding to the balance increasing transaction type on the left side of the chatroom and align the at least one of the messages corresponding to the balance decreasing transaction type on the right side of the chatroom.

### BRIEF DESCRIPTION OF THE FIGURES

The above and/or other aspects will be more apparent by describing certain example embodiments, with reference to the accompanying drawings, in which:

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components includable in a processor of an electronic device according to at least one example embodiment;

FIG. 4 is a flowchart illustrating an example of a method performed by an electronic device according to at least one example embodiment;

FIG. 5 illustrates an example of a screen of a chat interface that provides a transaction history of an account according to at least one example embodiment;

FIG. 6 illustrates an example of a screen of a chat interface that provides a convenience function related to a transaction history of an account according to at least one example embodiment;

FIG. 7 illustrates an example of a process of registering a memo through a chat interface that provides a transaction history of an account according to at least one example embodiment;

FIG. 8 illustrates an example of a screen of a chat interface that provides a one-to-one transaction history according to at least one example embodiment; and

FIG. 9 illustrates another example of a screen of a chat interface that provides a one-to-one transaction history according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for providing a transaction history of an account in a messenger banking service.

The example embodiments including the disclosure herein may provide a convenience function related to a transaction history of an account using a chat interface of a messenger and accordingly, may efficiently provide information about a transaction history and effectively use resources.

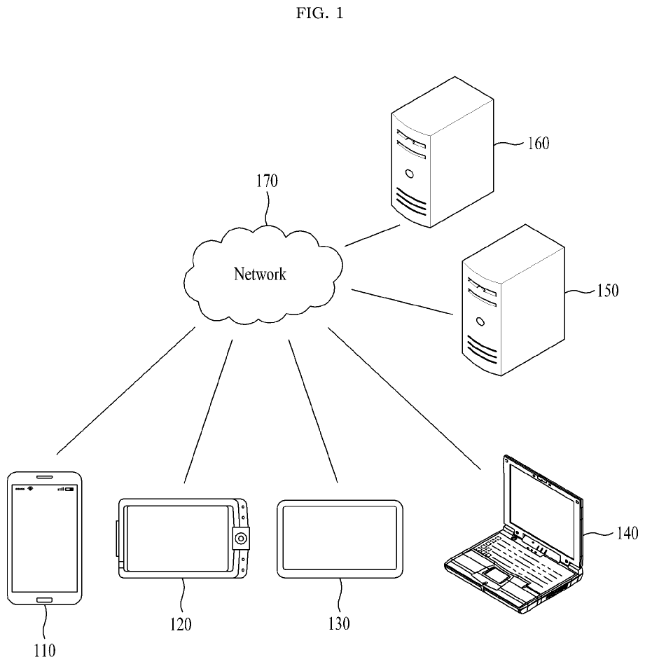

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (loT) device, a virtual reality (AR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, and the like through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide a service (e.g., a messenger banking service, etc.) intended by an application through the application as a computer program installed and executed on the plurality of electronic devices 110, 120, 130, and 140, as the first service. As another example, the server 160 may provide a service that distributes a file for installing and executing the application to the plurality of electronic devices 110, 120, 130, and 140, as the second service.

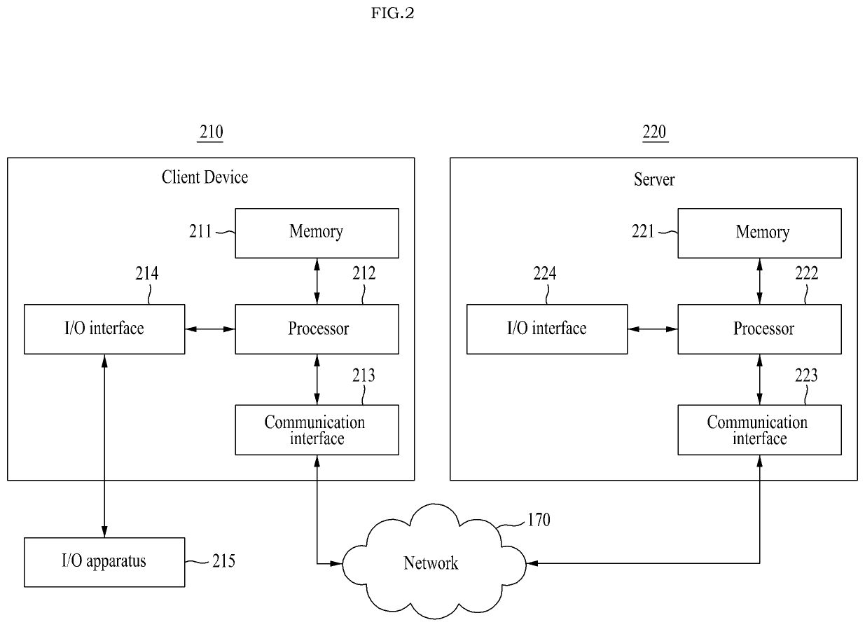

FIG. 2 is a block diagram illustrating an example of a client device 210 and a server 220 according to example embodiments. The client device 210 may correspond to any of the electronic devices 110, 120, 130, and 140 shown in FIG. 1, and the server 220 may correspond to any of the servers 150 and 160 shown in FIG. 1.

Referring to FIG. 2, the client device 210 may include a memory 211, a processor 212, a communication interface 213, and an input/output (I/O) interface 214, and the server 220 may include a memory 221, a processor 222, a communication interface 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the client device 210 or the server 220 as a permanent storage device separate from the memory 211, 221. Also, an OS or at least one program code, for example, a code for a browser installed and executed on the client device 210 or an application installed and executed on the client device 210 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication interface 213, 223, instead of the non-transitory computer-readable record medium. For example, at least one program may be loaded to the memory 211 of the client device 210 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication interface 213, 223 to the processor 212, 222. For example, the processor 212, 222 may be configured to execute received instructions in response to the program code stored in the storage device, such as the memory 211, 221.

The communication interface 213, 223 may provide a function for communication between the client device 210 and the server 220 over the network 170 and may provide a function for communication between the client device 210 and another client device or another server, and between the server 220 and another client device or server. For example, the processor 212 of the client device 210 may transfer a request created based on a program code stored in the storage device such as the memory 211, to the server 220 over the network 170 under control of the communication interface 213. The client device 210 may receive a control signal, an instruction, content, a file, etc., provided under control of the processor 222 of the server 220 through the communication interface 213 of the client device 210, from the communication interface 223 of the server 220. For example, a control signal, an instruction, content, a file, etc., of the server 220 received through the communication interface 213 may be transferred to the processor 212 or the memory 211, and content, a file, etc., may be stored in a storage medium, for example, the permanent storage device, further includable in the client device 210.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the client device 210. Also, the I/O interface 224 of the server 220 may be a device for interface with an apparatus for input or output that may be connected to the server 220 or included in the server 220. In detail, when the processor 212 of the client device 210 processes an instruction of a computer program loaded to the memory 221, content or a service screen configured based on data provided from the server 220 or the electronic device 120 may be displayed on the display through the I/O interface 214.

According to other example embodiments, the client device 210 and the server 220 may include a smaller or greater number of components than a number of components shown in FIG. 2. However, there is no need to clearly illustrate many components according to the related art. For example, the client device 210 may include at least a portion of the I/O apparatus 215, or may further include other components, for example, a transceiver, a global positioning system (GPS) module, a camera, a variety of sensors, a database (DB), and the like. In detail, if the client device 210 is a smartphone, the client device 210 may be configured to further include a variety of components, for example, an accelerometer sensor, a gyro sensor, a camera module, various physical buttons, a button using a touch panel, an I/O port, a vibrator for vibration, etc., which are generally included in the smartphone.

Hereinafter, examples of a method and system for providing a user convenience interface associated with a transaction history of an account are described.

Herein, a transaction history of an account may be aligned and displayed in a form of an in-chatroom message through a chatroom created for the account. In particular, the example embodiments may provide functions, such as a memo, an alert, and an alarm, addable to the transaction history of the account. It is possible to support a function of collecting and displaying a transaction history of a specific target by specifying a transaction target based on the transaction history of the account.

Herein, the term “chatroom” may represent an interface screen for providing messages exchanged between users. In the following, although a chatroom of a messenger is described as an example, it is provided as an example only. Any social networking service (SNS) interfaces interactable with a banking service may be applicable.

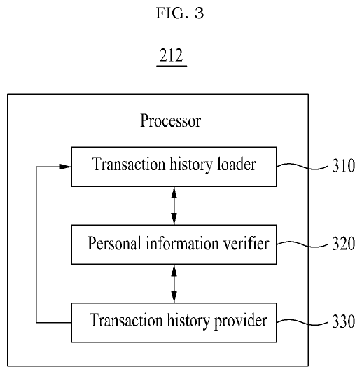

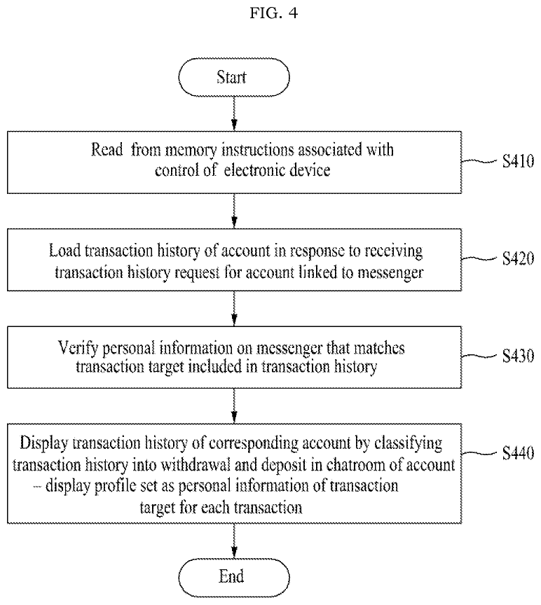

FIG. 3 illustrates an example of components includable in a processor of an electronic device according to at least one example embodiment and FIG. 4 is a flowchart illustrating an example of a method performed by an electronic device according to at least one example embodiment.

In one example, an account transaction history providing system implemented as a computer may be configured in the client device 210. For example, the account transaction history providing system may be configured in a form of an independently operating program or may be configured in an in-app form of a specific application to be operable on the specific application. Depending on cases, the account transaction history providing system may provide a messenger banking service through interaction with the server 220.

In response to an instruction provided from the application installed on the client device 210, the account transaction history providing system configured in the client device 210 may perform the account transaction history providing method of FIG. 4.

Referring to FIG. 3, to perform the account transaction history providing method of FIG. 4, the processor 212 of the client device 210 may include a transaction history loader 310, a personal information verifier 320, and a transaction history provider 330 as components. Depending on example embodiments, the components of the processor 212 may be selectively included in or excluded from the processor 212. Also, depending on example embodiments, the components of the processor 212 may be separated or merged for functional representation of the processor 212.

The processor 212 and the components of the processor 212 may control the client device 210 to perform operations S410 to S440 included in the account transaction history providing method of FIG. 4. For example, the processor 212 and the components of the processor 212 may be configured to execute an instruction according to a code of at least one program and a code of an OS included in the memory.

Here, the components of the processor 212 may be representations of different functions of the processor 212 performed by the processor 212 in response to an instruction provided from a program code stored in the client device 210, for example, an instruction provided from the application executed on the client device 210. For example, the transaction history loader 310 may be used as a functional representation of the processor 212 to control the client device 210 to load a transaction history of an account linked to a messenger in response to the instruction.

Referring to FIG. 4, in operation S410, the processor 212 may read from the memory 211 instructions associated with control of the client device 210. The read instruction may include an instruction for controlling the processor 212 to perform the following operations S420 to S440.

In operation S420, in response to the client device 210 on which a messenger is installed receiving a transaction history request for an account linked to the messenger, the transaction history loader 310 may load a transaction history of the corresponding account. For example, the client device 210 may generate the transaction history request upon receiving a user command for retrieving a transaction history associated with an account of the user. The transaction history loader 310 of the client device 210 may control the communication interface 213 to transmit the transaction history request to the server 220 through a messenger application installed on the client device 210, and may receive the transaction history from the server 220. Alternatively, the transaction history loader 310 may retrieve the transaction history from the (local) memory 211 of client device 210. In other words, in response to the transaction history request, the transaction history loader 310 may load the transaction history of the account linked to the messenger application installed on the client device 210 through interaction with the server 220 or through the local memory 211 of the client device 210. In response to the transaction history request, the transaction history loader 310 may load the transaction history of the corresponding account with balance information. Here, the transaction history may include a withdrawal history and a deposit history of the account, and may include account information (e.g., a financial institution, an account number, an account holder, etc.) of a transaction target, a transaction request memo (e.g., a bank statement, etc.), a transaction amount, a transaction time, and the like, for each transaction. The withdrawal history may further include information about a transaction type, for example, a remittance (transfer/send money), a payment, and a withdrawal. As another example, in addition to a message representing the transaction history, such as the deposit history and the withdrawal history of the account, the transaction history provider 330 may further load a user memo of the account linked to the messenger with user memo information (e.g., a memo input time). Here, the user memo may be a message sent from the user through the chatroom of the account and may include any type of contents creatable as a message, such as, for example, a text, a photo, a video, an audio, and various types of stickers.

In operation S430, the personal information verifier 320 may verify personal information on the messenger that matches the transaction target for each transaction target included in the transaction history of the account. The term “transaction target” may be also refer to an opponent, a trading opponent, a counterpart to the transaction, or a transaction counterpart. The personal information verifier 320 may verify whether a counterpart to a transaction that is made by the user of the client device 210 is a messenger user based on information about the counterpart (e.g., a user name, a user identification, a phone number, an e-mail address, an account number or ID of the counterpart) included in the transaction history. The personal information verifier 320 may acquire personal information of the counterpart that is registered in the messenger application if the counterpart is verified as a messenger user. For example, the personal information verifier 320 may transmit a counterpart verification request to the server 220, with information about the counterpart that is obtained from the transaction history. The personal information verifier 320 may receive, from the server 220, a verification success response indicating that the server 220 has found that the information of the counterpart matches one of the messenger user profiles that are registered in the server 220, or a verification failure response indicating that among the messenger user profiles registered in the server 220, there is no messenger profile matching the information of the counterpart. Here, the server 220 may store the verified messenger user in association with the transaction history. The server 220 may store the transaction history of the counterpart based on a predefined condition in association with profile information of the corresponding counterpart. For example, if a predetermined number of transactions occur within a predetermined period with respect to the same counterpart or if the same transaction iteratively occurs at predetermined intervals with respect to the same counterpart, the transaction history with the corresponding counterpart may be stored in association with profile information on the messenger. As another example, the transaction history verifier 320 may verify whether the counterpart is a user included in a friend list of the messenger installed on the client device 210.

In operation S440, the transaction history provider 330 may provide a chatroom of the account linked to the messenger as a chat interface of the messenger, and, here, may display the transaction history by classifying the transaction history into a withdrawal history and a deposit history based on a message type displayable on the chatroom of the account. The transaction history provider 330 may create a chatroom for each account linked to the messenger. Also, similar to a general chatroom form that displays messages exchanged between users, the transaction history provider 330 may display the transaction history of the account based on a message exchanged through a chatroom of the corresponding account. For example, the transaction history provider 330 may display the deposit history on the left side (like a received message) and may display the withdrawal history on the right side (like a sent message) in the chatroom of the account. Also, the transaction history provider 330 may align and display the transaction history of the account in order of transaction time. In detail, the transaction history provider 330 may display the transaction history such that a message associated with a recent transaction is displayed at a bottom or in a lower portion of the chatroom.

In particular, when providing the transaction history of the account through the chatroom of the corresponding account, the transaction history provider 330 may display a profile set as personal information on the messenger with respect to the counterpart for each transaction. That is, the transaction history provider 330 may display transaction content for each transaction based on a message in the chatroom of the account, and here, may display the transaction content in association with the profile of the counterpart to the transaction, on the messenger. If the corresponding transaction is made using a financial service interactable with a messenger application, a social graph managed by the server 220, or the user information, user information (e.g., a messenger identifier of the counterpart or an identifier of the counterpart managed by the messenger application) on the messenger with respect to the counterpart may be included in counterpart information. Subsequently, when displaying the transaction history, the transaction history provider 330 may refer to and then display the profile of the corresponding counterpart on the messenger stored in the server 220 using user information on the messenger with respect to the counterpart included in the counterpart information. For example, in response to a remittance request from a messenger user Cony for transferring money to a messenger user Brown using a user interface in the messenger, unique ID information of Brown managed by the messenger application or a user ID of Brown may be sent to a server that provides a banking service with the remittance request. Once remittance, that is, transfer from Cony to Brown in response to the remittance request is completed as a single banking service, the transaction history provider 330 may refer to and display a profile of Brown on the messenger stored in the server 220 using the ID information or the user ID of Brown included in counterpart information when displaying a transaction history for the corresponding remittance, that is, transfer. Meanwhile, if user information on the messenger with respect to the counterpart is not included in the counterpart information, whether user information associated with the counterpart is present on the messenger may be determined using the counterpart information. If the user information associated with the counterpart is present on the messenger, the transaction history provider 330 may display a profile of a user associated with the user information. For example, when a withdrawal is made from a bank account of Cony with respect to a transaction at a digital media distribution store, named LINE Friends, by the messenger user Cony, user information of the counterpart on the messenger may not be included in the corresponding counterpart information. Here, whether an official account associated with the counterpart is present on the messenger may be determined using the name “LINE Friends”, etc., included in the counterpart information, and, when the official account on the messenger associated with “LINE Friends” is determined to be present, the transaction history provider 330 may display a profile of the corresponding official account. As another example, when the user information on the messenger with respect to the counterpart is not included in the counterpart information, the corresponding counterpart may be associated with another user on the messenger by the user. Here, with respect to the same counterpart to the transaction, the transaction history provider 330 may display a profile of the other user associated by the user. For example, with respect to a transaction about a remittance (i.e., money transfer/send money) from the messenger user Cony to XYZ bank 123-333222-00011 (account holder “Sally Kim”), the counterpart Sally Kim may be associated with another user Sally on the messenger. Here, with respect to a transaction that is determined to include the same counterpart based on an account holder name, an account number, a transaction memo, etc., including the corresponding transaction, a profile of Sally may be displayed.

Transaction content displayed as a message may be reconfigured based on information included in the transaction history. For example, the withdrawal history may include a transaction type, a recipient or a customer, a transaction amount, and a transaction time. The deposit history may include a sender, a bank statement, a transaction amount, and a transaction time. Also, in addition to the deposit history or the withdrawal history, the transaction history provider 330 may display a user memo to be distinguished from a message representing a transaction history, such as the deposit history or the withdrawal history, based on a message. Here, the transaction history provider 330 may sequentially display messages based on user memo information and each transaction time of the transaction history. A memo message corresponding to the user memo may be displayed in association with the profile of the user of the electronic device 110 on the messenger.

Accordingly, the transaction history provider 330 may provide the transaction history of the corresponding account through the chatroom of the account linked to the messenger, and, particularly, display transaction content for each transaction based on a message. Here, the transaction history provider 330 may provide a user convenience interface capable of further intuitively and efficiently distinguishing an entity from which transaction content is originated by displaying the transaction content for each transaction in association with a profile of the counterpart on the messenger.

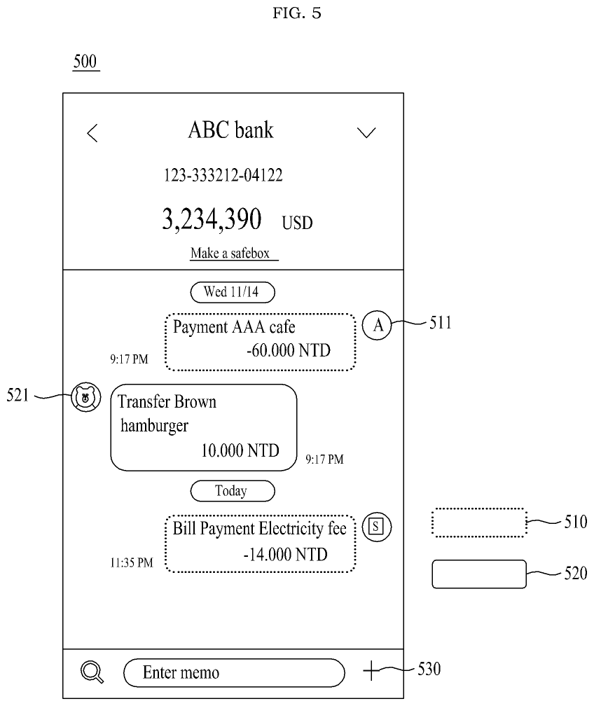

FIG. 5 illustrates an example of a screen of a chat interface that provides a transaction history of an account according to at least one example embodiment.

FIG. 5 illustrates a chatroom 500 of an account linked to a messenger.

Referring to FIG. 5, a transaction history including a deposit history and a withdrawal history through the account may be displayed with balance information of the account on the chatroom 500. The deposit history may include history of deposits, credit-type transactions that have been direct deposited or that have been entered for the account, and any other additions to the balance of the account. The withdrawal history may include history of withdrawals, payments, and any other subtractions from the balance of the account. In other words, the deposit history and the withdrawal history may include account balance increasing transactions and account balance decreasing transactions, respectively. The processor 212 or the processor 222 may determine whether each transaction included in the transaction history is a balance increasing transaction that belongs to the deposit history or a balance decreasing transaction that belongs to the withdrawal history. In the case of providing the transaction history of the account through the chatroom 500, the transaction history provider 330 may display transaction content for each transaction in the form of messages. For example, the transaction history provider 330 may control to display one or more message containers that house the transaction content/detail for each transaction. Here, the withdrawal history may be displayed on the right side of the chatroom 500 in a dotted line message container 510, and the deposit history may be displayed on the left side of the chatroom 500 in a solid line message container 520, as a right-aligned chat bubble indicates a sent message and a left-aligned chat bubble indicates a received message.

The processor 212 of the client device 210 may execute a computer-readable instruction that is stored in the memory 211 or received from the server 220, wherein the computer-readable instruction defines the layout of each message item to contain a user or transaction counterpart's name, a user or transaction counterpart's profile image, a timestamp, and a transaction detail (e.g., a transaction type such as a wire transfer, a bill payment, etc., an amount of the transaction, etc.). The computer-readable instruction may also define the alignment of message containers (e.g., chat bubbles) based on a type of the transaction.

As shown in FIG. 5, the transaction history provider 330 may display a profile 511, 521 of a counterpart to the transaction, on the messenger, as a type of an entity that represents a message source with respect to each message contained in the message container 510, 520. For example, a profile on the messenger of a counterpart that made a deposit to the user of the client device 210 may be displayed in the profile 521 of the message 520 representing the deposit history. Also, a profile on the messenger of the user of the client device 210 may be displayed as the profile of the message contained the dotted line message container 510 representing the withdrawal history. Alternatively, a profile on the messenger that matches the counterpart may be displayed depending on a transaction type instead of displaying a user profile. For example, if the user of the client device 210 has a remittance history, that is, a money transfer history for an individual, the transaction history provider 330 may display a profile of the user on the messenger. If the user has a payment history at a store or for utility bills, the transaction history provider 330 may display a profile of the corresponding store or a corresponding office on the messenger. With respect to a transaction history with a counterpart having an official account of the messenger in the withdrawal history, the transaction history provider 330 may display a profile of the official account in the profile 511 of the message representing the corresponding history. A holder of the official account may modify desired profile information (any type of content, such as a text, an image, a video, a uniform resource locator (URL) link includable in a profile). If profile information of the official account is modified, the profile information modified by a corresponding owner may be exposed to users that verify the transaction history.

Unlike existing related art method of providing a transaction history of an account in a simple list at a messenger banking service, the example embodiment may provide a method and an apparatus for classifying the transaction history into a withdrawal history and a deposit history in a form of a chatroom through which messages are exchanged and may display the withdrawal history and the deposit history to be aligned on the left and the right, such that the transaction history may be easily identified.

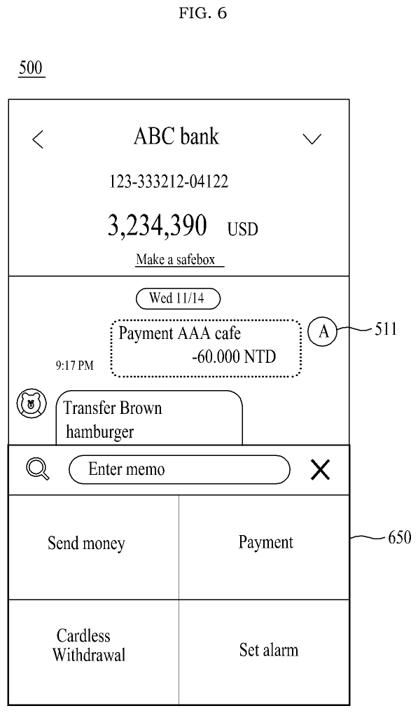

FIG. 6 illustrates an example of a screen of a chat interface that provides a user convenience interface (hereinafter, “convenience interface”) related to a transaction history of an account according to at least one example embodiment.

Referring to FIG. 6, the transaction history provider 330 may provide a convenience interface 650 for providing a user memo, a notification, etc., as an interface in the corresponding chatroom 500 through the chatroom 500 that provides the transaction history of the account. For example, in response to an input of a menu call button 530 in the chatroom 500 of FIG. 5, the convenience interface 650 may be displayed in a menu list in the chatroom 500.

The convenience interface 650 may include a user interface that initiates a remittance, that is, money sending function, a payment function, and a withdrawal function using the account of the chatroom 500. Also, the convenience interface 650 may further include a user interface that initiates a user memo function capable of uploading a memo in the chatroom 500, an alarm setting function (or an alert setting function) capable of setting an alarm (or an alert) associated with the chatroom 500. That is, the transaction history provider 330 may integrally provide the convenience interface 650 that is available in association with the account and the transaction history of the account through the chatroom 500 that provides a transaction history of each account linked to the messenger.

In the chatroom 500, each account is specified as a chat interface that provides a transaction history of the corresponding account. Therefore, a remittance, a withdrawal, a payment, etc., may be immediately performed without a process of designating a transaction account to in the chatroom 500.

A user memo function enables a user to create a memo through a message input box of the chatroom 500. Here, similar to a method of creating and sending a message in the chatroom 500, the memo may be input using any type of contents creatable as a message, such as, for example, a text, a photo, a video, an audio, and various types of stickers.

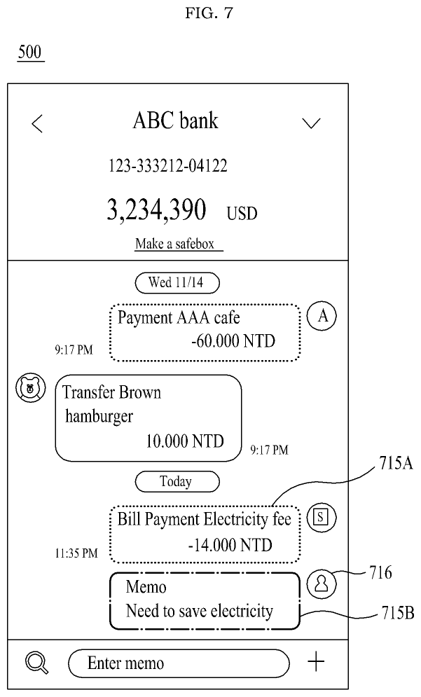

If the user creates a memo through the message input box of the chatroom 500 and then pushes a send button, the memo may be immediately registered as a memo of a corresponding account and may be displayed as an individual message 715B in the chatroom 500 as shown in FIG. 7. A profile of the user of the client device 210 on the messenger may be displayed in a profile 716 of the message 715B including memo content. Information indicating that the message 715B is a memo may be displayed. For example, when the user selects a message 715A displayed in the chatroom 500 and then enters the text of the message 715B in the message input box, the processor 212 may control to display the message 715B in the chatroom 500 in association with the message 715A, for example by displaying the message 715B on the same side of the chatroom 500 as the message 715A, and/or displaying the message 715B immediately below the message 715A. Alternatively, the message 715B indicating the memo may be displayed to be distinguished from other memos, for example, the messages contained the message containers 510 and 520 representing the transaction history.

In the chatroom 500, memos directly created by the user may be displayed in temporal order. The user may input and register a desired memo at a point in time suitable for content and context of a transaction history of an account provided through the chatroom 500. Instead of registering a memo subject to corresponding transaction content for each transaction, the user may create and register a memo through the message input box of the chatroom 500. Accordingly, the memo may be processed as the same level of an individual transaction as each piece of transaction content displayed based on a message and may be displayed based on an individual message of the chatroom 500. Through this, the memo use range may be expanded. That is, in response to a memo registration request for registering the memo to the chatroom 500 through the user interface in the chatroom 500, a message representing the memo may be processed as an individual transaction and added to the chatroom 500.

The alarm function may provide an interface for inputting a time setting and alarm content. Through this, in the case of setting an alarm, the alarm may be registered as an alarm associated with the chatroom 500. For example, at a set alarm time, the transaction history provider 330 may provide an alarm of outputting the alarm content in a form of a message sent from the user or an official account associated with the account through the chatroom 500.

Similar to the memo, a notification message according to the alarm setting may be processed as an individual transaction and added to the chatroom 500, and may be displayed to be distinguished from the messages contained the message containers 510 and 520 representing the transaction history. In response to an alarm setting request for setting an alarm associated with the chatroom 500 through the user interface in the chatroom 500, a message representing the alarm may be processed as an individual transaction and added to the chatroom 500.

The alarm function may further include a scheduled remittance function, that is, a scheduled transfer function through setting of an account and an amount. The transaction history provider 330 may provide a notification about a scheduled transfer through the chatroom 500. The notification about the scheduled transfer may include the account and the amount preset through the alarm function and may also include an interface that enables an immediate remittance, that is, transfer.

A message reservation and send interface may be provided to enable the scheduled transfer. By registering a message corresponding to the scheduled transfer with a scheduled send time, the corresponding message may be set to be sent at the scheduled send time instead of being immediately sent at a time of registration. Accordingly, a remittance, that is, a transfer may be performed at the corresponding time.

As another example, an interface that enables a scheduled transfer may be provided by sending a message corresponding to the scheduled transfer in the chatroom 500. Since an account to which money is to be transferred is specified in the chatroom 500, the scheduled transfer may be simply registered by including a transfer time, a recipient account, and an amount in the message and sending the message. For example, if a message “transfer 100,000 won to Sally at 10 AM tomorrow” is sent on Jan. 1, 2019, in the chatroom 500, a scheduled transfer for transferring 100,000 won to an account of Sally at 10 AM on Jan. 2, 2019, which is the next day of the day on which the message is sent may be registered. Here, although the user does not input the recipient account or the exact date, an account number of Sally may be specified based on a friend list or a transaction history and the transfer time may be specified based on a message sent time. Likewise, it is possible to provide an interface for referring to or cancelling scheduled transfer statement by sending a message in the chatroom 500.

Although a memo and an alarm are described to be displayed in a form of a message sent from the user, it is provided as an example only. They may be output in a form of a message forwarded from a system as a neutral interface of the chatroom 500. It is to use an interface of notifying a new user that participates in the chatroom 500 or an interface of distinguishing a date, and the like, on the messenger. In the case of the message corresponding to the memo and the alarm, not a chat-type message but a system of a neutral position may forward content.

According to example embodiments, through the chatroom 500, the user may input a memo of desired content at a desired position based on content and context of a transaction history, and may set an alarm to receive a notification at a desired point in time. Therefore, it is possible to improve a user convenience and to efficiently use resources by using resources related to the messenger.

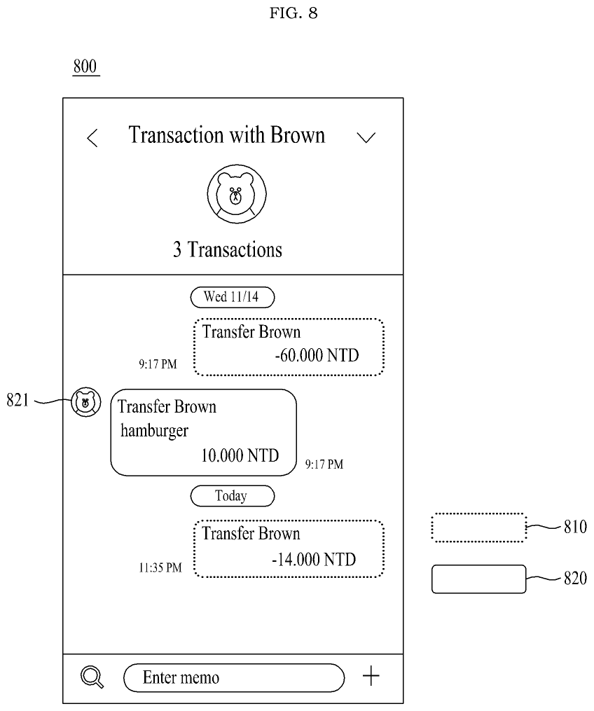

FIG. 8 illustrates an example of a screen of a chat interface that provides a one-to-one transaction history according to at least one example embodiment.

FIG. 8 illustrates an example of a one-to-one transaction history screen 800.

In response to a selection on a profile of a specific target (e.g., a transaction counterpart or a chat participant) in a regular chatroom or the chatroom 500 of FIG. 5, the transaction history provider 330 may provide a transaction history of the selected transaction target through the one-to-one transaction history screen 800 in a form of a one-to-one chat as shown in FIG. 8.

The transaction history provider 330 may display a remittance history, that is, a money transfer history from the user of the client device 210 to a specific target, on the right side of the one-to-one transaction history screen 800, as being housed in a dotted line message container 810. The transaction history provider 330 may display a remittance history, that is, a money transfer history from the specific target to the user of the client device 210, on the left side of the one-to-one transaction history screen 800, as being housed in a solid line message container 820.

That is, it is possible to specify a transaction target (e.g., a transaction counterpart) through a profile selection in the chatroom 500 that provides the entire transaction history of the account, to select a history exchanged with the specific target, and to display the same in a one-to-one chat form. The one-to-one transaction history screen 800 may perform filtering of the transaction history with the specific target from the entire transaction history and may provide the transaction history with the specific target as a filtering result screen that pops up on the chatroom 500. Also, the transaction history may be provided in a separate chatroom form.

On the one-to-one transaction history screen 800, a transaction history with the selected counterpart using one or more accounts linked to the chatroom 500 may be displayed based on a message. For example, in response to a selection on a profile associated with a deposit history from 9:17 PM Brown on the chatroom 500 of FIG. 7, the chatroom 500 may be switched to the one-to-one transaction history screen 800. Here, only a transaction history with Brown using ABC bank 123-333212-04122 may be displayed or a transaction history with Brown with respect to accounts linked to the messenger, including ABC bank 123-333212-04122 may be displayed, on the one-to-one transaction history screen 800.

Similar to the chatroom 500, the one-to-one transaction history screen 800 may provide a convenience function, such as a memo, a notification, and the like. The convenience function of the one-to-one transaction history screen 800 may include a remittance function that enables an immediate transfer to a specific target, a memo function for registering a user memo associated with a transaction history with the specific target, an alarm setting function for setting an alarm associated with the transaction history with the specific target, and the like.

Since the transaction target is specified, a remittance (transfer/send money), a memo registration, and an alarm setting may immediately proceed on the one-to-one transaction history screen 800 without a process of designating a target to which money is to be transferred. The memo registered on the one-to-one transaction history screen 800 may be processed to be displayed only for the user of the client device 210 or may be processed to be in a form shareable with the specific target.

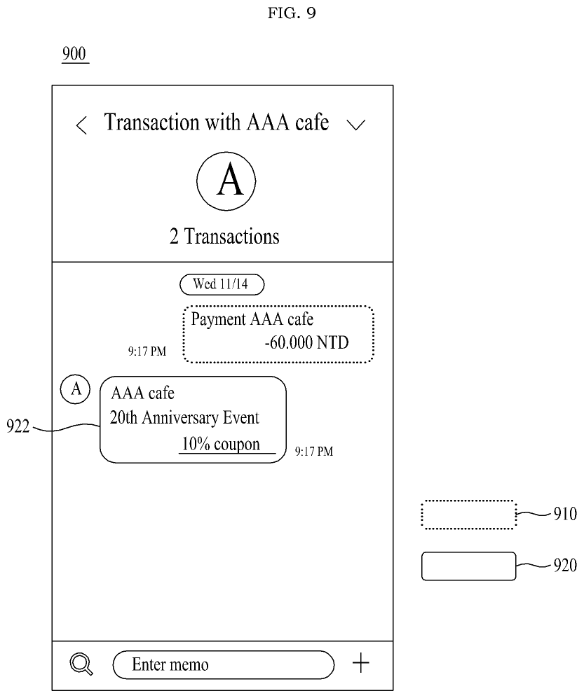

FIG. 9 illustrates another example of a screen of a chat interface that provides a one-to-one transaction history according to at least one example embodiment.

FIG. 9 illustrates an example of a one-to-one transaction history screen 900.

With respect to a transaction history with a specific target having an official account of a messenger in a withdrawal history of the user of the client device 210, a profile of the official account may be displayed in the profile 511 representing the corresponding history on the chatroom 500 of FIG. 5.

If the counterpart having the official account of the messenger is specified through a profile selection on the chatroom 500 of FIG. 5, the transaction history provider 330 may provide the transaction history with the specific target through the one-to-one transaction history screen 900 in a one-to-one chat form. On the one-to-one transaction history screen 900, the transaction history provider 330 may display a withdrawal history on the right side of the one-to-one transaction history screen 900 by using a dotted line message container 910. Here, the transaction history provider 330 may display content 922 designated for the official account of the specific target, on the left side of the one-to-one transaction history screen 900 by using a solid line message container 820.

The content 922 and a display condition of the content 922 may be designated for the official account through a presetting. For example, if the transaction history with the specific target meets the display condition of the content 922, the transaction history provider 330 may display the content 922 on the one-to-one transaction history screen 900. For example, if a coupon that is provided to a user having a transaction history of at least once is designated in an official account of AAA cafd, the coupon may be displayed at a point in time at which the transaction history occurs at least once through the one-to-one transaction history screen 900 that provides the transaction history in AAA cafd. As another example, through the one-to-one transaction history screen 900, the transaction history provider 330 may add up the transaction history with the specific target and may provide an addition result or may provide various types of event or promotion information as content associated with the specific target based on the addition result. For example, in response to a selection from the user on an official account profile of a debit card linked to the account on the chatroom 500, the transaction history provider 330 may collect and display only a transaction history of the corresponding debit card on the one-to-one transaction history screen 900. Here, the transaction history provider 330 may display an accumulated amount during a unit period, or may display event or promotion information of the debit card.

As described above, according to example embodiments, by providing an interface that displays a profile of a transaction target (e.g., a transaction counterpart) for each transaction with transaction content through an account chatroom and, in response to a selection on a profile of a specific target (e.g., a chat participant or a transaction counterpart) in the account chatroom, selects only a history exchanged with the specific target and displays only the selected history on another screen, it is possible to assist a search for an account transaction history and to maximize the utilization.

According to some example embodiments, it is possible to provide a transaction history of an account in a form of a chatroom and to provide a profile of a transaction target on a messenger for each transaction. Also, according to some example embodiments, it is possible to provide a function of a memo, a notification, etc., as an interface in a corresponding chatroom through the chatroom that provides a transaction history of an account for user convenience. Also, according to some example embodiments, it is possible to collect and provide a transaction history with a specific target through a profile selection on a transaction history chatroom. With respect to a transaction target having an official account of a messenger, it is possible to provide content associated with the transaction target through the transaction history chatroom.

The systems or the apparatuses described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the example embodiments may be recorded in non-transitory computer-readable storage media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable storage media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments, or vice versa.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A computer system comprising:
a memory configured to store computer-readable instructions;
at least one processor configured to execute the computer-readable instructions to:
load a transaction history of an account of a user of a messenger application based on receiving a transaction history request for the account;
verify whether a transaction counterpart included in the transaction history of the user is registered in the messenger application; and
based on verifying that the transaction counterpart is registered in the messenger application, display, in a chatroom created for the account to, transaction details for each transaction of the transaction history in a message form in association with a profile of the transaction counterpart registered in the messenger application.

2. The computer system of claim 1, wherein the at least one processor is further configured to classify the transaction history into a withdrawal history and a deposit history, and control to display the transaction details visually distinctly according to a classification of the transaction history.

3. The computer system of claim 1, wherein the at least one processor is further configured to display a profile of the user of the account on the messenger application or the profile of the transaction counterpart on the messenger application based on a transaction type.

4. The computer system of claim 1, wherein the at least one processor is further configured to provide a user interface that is incorporated into the chatroom and initiates at least one of a memo function for entering a memo to the chatroom or an alert function for setting an alert associated with the chatroom.

5. The computer system of claim 4, wherein the at least one processor is further configured to generate a memo message including the memo and control to display the memo message in the chatroom based on receiving a memo registration request, or generate an alert message including the alert and control to display the alert message in the chatroom based on receiving an alarm setting request.

6. The computer system of claim 1, wherein the at least one processor is further configured to select the transaction history associated with the transaction counterpart, among a plurality of transaction counterparts included in the transaction history, and open a new display window to display the selected transaction history in the new display window, based on selecting the profile of the transaction counterpart in the chatroom.

7. The computer system of claim 6, wherein the at least one processor is further configured to provide content designated for an official account of the transaction counterpart in the new display window based on the official account being registered in the messenger application.

8. An account transaction history providing method comprising:
loading a transaction history of an account of a user of a messenger application based on receiving a transaction history request for the account;
verifying where a transaction counterpart included in the transaction history of the user is registered in the messenger application; and
based on verifying that the transaction counterpart is registered on the messenger application, displaying, in a chatroom created for the account to, transaction details for each transaction of the transaction history in a message form in association with a profile of the transaction counterpart registered in the messenger application.

9. The account transaction history providing method of claim 8, further comprising:
displaying the transaction history by classifying the transaction history into a withdrawal history and a deposit history, and displaying the transaction details visually distinctly according to a classification of the transaction history.

10. The account transaction history providing method of claim 8, further comprising:
displaying a profile of the user of the account on the messenger application or the profile of the transaction counterpart on the messenger application based on a transaction type.

11. The account transaction history providing method of claim 8, further comprising:
displaying a profile of the user of the account in association with a withdrawal history of the transaction history; and
displaying the profile of the transaction counterpart based on an official account of the transaction counterpart being registered in the messenger application.

12. The account transaction history providing method of claim 8, further comprising:
providing a user interface that is incorporated into the chatroom and initiates at least one of a remittance function, a payment function, and a withdrawal function.

13. The account transaction history providing method of claim 8, further comprising:
providing a user interface that initiates at least one of a memo function for entering a memo to the chatroom or an alert function for setting an alert associated with the chatroom.

14. The account transaction history providing method of claim 13, further comprising:
generating a memo message including the memo and displaying the memo message in the chatroom based on receiving a memo registration request, or generating an alert message including the alert and displaying the alert message in the chatroom based on receiving an alarm setting request.

15. The account transaction history providing method of claim 8, further comprising:
selecting the transaction history associated with a transaction counterpart, among a plurality of transaction counterparts included in the transaction history; and
opening a new display window to display the selected transaction history in the new display window, based on selecting the profile of the transaction counterpart in the chatroom.

16. The account transaction history providing method of claim 15, wherein the opening the new display window to display selected transaction history in the new display window comprises providing a user interface that initiates at least one of a remittance function, a memo function, and an alert function for the transaction counterpart.

17. The account transaction history providing method of claim 15, wherein the opening the new display window to display selected transaction history in the new display window comprises providing content designated for an official account of the transaction counterpart in the new display window based on the official account being registered in the messenger application.

18. The account transaction history providing method of claim 15, wherein the opening the new display window to display selected transaction history in the new display window comprises based on determining that the transaction counterpart has an official account registered in the messenger application, and the transaction history associated with the transaction counterpart satisfies a display condition of a content designated for the official account, providing the content designated for the official account in the new display window.

19. A non-transitory computer-readable storage medium storing a computer program that is executable by a computer to perform the account transaction history providing method of claim 8.

20. A computer system comprising:
a memory configured to store computer-readable instructions;
at least one processor configured to execute the computer-readable instructions to:
load a transaction history of an account of a user registered in a messenger application;
identify at least one transaction counterpart to a plurality of transactions included in the transaction history;
determine a transaction type of each of the plurality of transactions, the transaction type corresponding to a balance increasing transaction type or a balance decreasing transaction type; and
based on determining that the at least one transaction counterpart is registered in the messenger application, create a graphic user interface of a chatroom for the account of the user, generate messages that respectively contain details of the plurality of transactions, and determine a layout of each of the messages in the chatroom according to the transaction type of each of the plurality of transactions.

21. The computer system of claim 20, wherein the at least one processor is further configured to execute the computer-readable instructions to:
align at least one of the messages corresponding to the balance increasing transaction type on a right side of the chatroom and align at least one of the messages corresponding to the balance decreasing transaction type on a left side of the chatroom, or
align the at least one of the messages corresponding to the balance increasing transaction type on the left side of the chatroom and align the at least one of the messages corresponding to the balance decreasing transaction type on the right side of the chatroom.
